(19) United States
(12) Patent Application Publication
(10) Pub. No.: US 2008/0104360 A1
(43) Pub. Date: May 1, 2008

(54) STORAGE VIRTUALIZATION SWITCH AND COMPUTER SYSTEM

(75) Inventors: Jun TAKEUCHI, Kawasaki (JP); Toshitaka Yanagisawa, Kawasaki (JP); Tetsuya Kinoshita, Kawasaki (JP); Takaaki Yamato, Kawasaki (JP); Toshiaki Takeuchi, Kawasaki (JP); Atsushi Shinohara, Kawasaki (JP); Yusuke Kurasawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/849,013

(22) Filed: Aug. 31, 2007

(30) Foreign Application Priority Data
Oct. 31, 2006 (JP) 2006-296291

(51) Int. Cl. G06F 12/00

(52) U.S. Cl. 711/203; 711/E12.001

(57) ABSTRACT

The storage virtualization switch is capable of omitting to control (exclusion-control) a reserve condition on a physical storage unit without decreasing fault tolerance and reliability, so that overhead of access to the storage unit can be smaller. The storage virtualization switch comprises: a storage virtualization unit for constituting a virtual storage unit by using a storage area of the physical storage unit; a communication unit for communicating with another storage virtualization switch; and a zoning unit for making a host computer recognize an external virtual storage unit constituted in another storage virtualization switch connected by the communication unit, the zoning unit making the host computer access the external virtual storage unit via the communication unit when the host computer requests to access the virtual storage unit.

### BACKGROUND OF THE INVENTION

The present invention relates to a storage virtualization switch comprising connection terminals, to which a host computer and a physical storage unit can be connected, and storage virtualization means for constituting a virtual storage unit, to which the host computer can access, by using a part or a whole of a storage area of the physical storage unit, and a computer system including the storage virtualization switches.

In a computer system including a plurality of physical storage units, a storage virtualization technology, in which a host computer recognizes combined storage areas of the physical storage units, e.g., magnetic disk units, as a virtual storage unit, has been applied.

A conventional computer system is disclosed in Japanese Patent Kokai Gazette No. 2003-44421. The computer system is shown in FIG. 6. A plurality of host computers (nodes) 1 and a plurality of physical storage units (real disks) 2 are mutually connected by a network switch 3, which acts as a storage virtualization switch, via fiber channels. A network processor 31 of the network switch 3 combines parts or wholes of storages areas of the physical storage units 2 so as to constitute a virtual storage unit 5, to which the host computers 1 can access.

By the storage virtualization switch (network switch), a user can optionally constitute a virtual storage unit (volume), which is suitable for the host computers. The host computers can use the physical storage units, by accessing the virtual storage unit, without recognizing storage capacity, connection modes, etc. of the physical storage units.

In another computer system, a plurality of storage virtualization switches are used to form redundant paths so as to improve reliability of the computer system. This computer system is shown in FIG. 7.

In FIG. 7, a plurality of host computers 11a and 11b and a RAID storage unit 14, which is constituted by a plurality of physical storage units X and Y, are connected to two storage virtualization switches 10a and 10b via the connection terminals 12a-12j and fiber channels FC.

Each of the storage virtualization switches 10a and 10b makes the host computers 11a and 11b recognize virtual storage units (volumes) A and B, which have the same structures, via a virtual target VT. Namely, the host computers 11a and 11b are capable of similarly accessing the virtual storage units A and B via the storage virtualization switch 10a or 10b. The system, in which a plurality of the storage virtualization switches are multiplexed so as to form the redundant paths, is called a multinode system.

By employing the multinode redundant system, even if one of the storage virtualization switch 10a or 10b breaks down, the system can continuously operate so that fault tolerance of the system can be improved.

In FIG. 7, each of the storage virtualization switches 10a and 10b includes the virtual storage units A and B. The virtual storage unit A is constituted by an upper part a1 of the physical storage unit X and an upper part a2 of the physical storage unit Y; the virtual storage unit B is constituted by a lower part b 1 of the physical storage unit Y and a lower part b2 of the physical storage unit X. The host computes 11a and 11b are capable of accessing the virtual storage units A and B via the virtual target VT.

Note that, the structures of the virtual storage units (volumes) in the storage virtualization switches 10a and 10b are not limited to the above described example. The virtual storage units may be constituted by optionally combining parts or wholes of storage areas of the physical storage units.

In case of virtualizing the storage units and using the multinode redundant system, it is necessary to control (exclusion-control) reserve of an access right (request to occupy an access right) on the RAID storage unit 14 between the storage virtualization switches 10a and 10b.

While one of the storage virtualization switches accesses the RAID storage unit 14 (the physical storage units X and Y), if another storage virtualization switch accesses the RAID storage unit 14 (the physical storage units X and Y), data accessed by the one storage virtualization switch will be destroyed. Namely, failures occur. Especially, in case of virtualizing the storage units, a plurality of the physical storage units will be simultaneously accessed, by the storage virtualization switch, in answer to the access of the host computer to one virtual storage unit. Therefore, the reserve must be simultaneously performed to a plurality of the physical storage units.

Conventionally, the multinode storage virtualization switches 10a and 10b mutually communicate by a plurality of the network communication means 13a and 13b, e.g., Ethernet (registered trademark) communication means, so as to control (exclusion-control) the reserve (see FIG. 7).

For example, the storage virtualization switch 10b transmits a notice of performing the reserve on the RAID storage unit 14 (the physical storage units X and Y) to the storage virtualization switch 10a before performing the reserve on the RAID storage unit 14, waits for a reply to the notice, and then transmits a signal for performing the reserve on the RAID storage unit 14 (the physical storage units X and Y). If the reserve on the RAID storage unit 14 (the physical storage units X and Y) is performed when the storage virtualization switch 10a receives the notice, the storage virtualization switch 10a waits until terminating the access, and then replies to the notice; if no reserve is performed, the storage virtualization switch 10a immediately replies to the notice.

By controlling (exclusion-controlling) the reserve condition on accessing the RAID storage unit 14 (the physical storage units X and Y) between the storage virtualization switches 10a and 10b by using the Ethernet (registered trademark) communication means, serious failures, e.g., data destruction, can be prevented.

By providing a plurality of the network communication means 13a and 13b so as to form the redundant system as shown in FIG. 7, even if a failure occurs in one of the network communication means 13a and 13b, the communication relating to the reserve can be performed by the other network communication means so that fault tolerance of the Ethernet (registered trademark) communication can be improved.

Conventionally, data are copied and stored in a plurality of storage units, e.g., mirroring units, so as to improve reliability of a storage system.

The copy is performed by, for example, a migration technology or a replication technology.

By the migration technology, all data stored in the storage units are copied. Therefore, this technology is mainly used for changing storage units.

By the replication technology, a selected storage area or areas of the storage units are copied. Therefore, this technology is mainly used for making a backup copy or copies of selected data.

In some cases, a DRL (Dirty Region Logging) technology is used in a mirroring process. A general DRL technology will be explained with reference to FIG. 8.

The DRL technology is used when data cannot be copied in a copy destination storage unit (mirror volume) MX due to, for example, system failure. In such case, the DRL function is executed by the network switch 18a or 18b when the host computer 11 requests to access a copy source storage unit (volume) X via the multinode network switch 18a or 18b. A control section of the network switch 18a or 18b rewrite the stored data of the copy source storage unit X according to an access request for writing data. If copying data to the copy destination storage unit MX cannot be executed due to the system failure, the DRL function writes “rewritten data in the storage area of the copy source storage unit X, to which the access has been requested, are not reflected in or copied to the copy destination storage unit MX” in a log. The log is stored in a log storage unit Z, which is called, for example, a backing store volume. Generally, the log is a bitmap constituted by flags, each of which indicates if data in each LBA (Logical Block Addressing) sector of the storage unit X are copied or not. By using the DRL technology, when the failure is recovered, a mirroring condition can be immediately recovered by copying the uncopied data only to the copy destination storage unit MX.

Further, a snapshot technology for coping data is also known. The snapshot technology is used for copying data stored in a copy source storage unit to a copy destination storage unit at a particular time.

In case of using the snapshot technology, a COW (Copy On Write) technology is sometimes used. While copying data by performing the snapshot technology, the COW technology is used for continuously operating the computer system so as to allow the host computer 11 to access the storage unit X.

The COW technology will be explained with reference to FIG. 8.

The COW function is executed when the host computer 11 sends an access request for writing data in the storage area of the storage unit X, which has not been copied by the snapshot technology, via the network switch 18a or 18b. In this case, the access request for writing data is sent after the request of performing the snapshot technology, so the data stored in the storage unit X must be copied to the copy destination storage unit MX before the writing action replying to the access request. Firstly, the COW function, which is executed by the network switch 18a or 18b, copies the LBA sector of the copy source storage unit X including the storage area, to which the access request for writing data has been requested, to the storage unit MX. Next, the COW function writes “the storage area has been copied” in a log. When the snapshot technology executes the copying action, the COW function skips the copied storage area so as not to copy the data which have been already written. The log is a bitmap constituted by flags, each of which indicates if data in each LBA (Logical Block Addressing) sector of the storage unit X are copied or not, as well as the DRL technology. The log is stored in the log storage unit Z, which is called, for example, the backing store volume.

To access the storage unit Z or the backing store volume of the DRL or COW technology, the reserve condition must be controlled (exclusion-controlled). Namely, the multinode network switch 18a or 18b communicates or exclusion-controls the reserve condition via the network communication means 13a and 13b so as not destroy the contents of the log stored in the log storage unit (backing store volume) Z.

In the conventional computer system including the multinode storage virtualization switches (network switches), the reserve condition for accessing the physical storage unit must be controlled (exclusion-controlled), by the network communication means, etc., between the network switches.

Generally, a communication speed between the network switches for communicating the reserve condition on the physical storage unit is very slower than that of the fiber channel FC between the host computer and the physical storage unit. Therefore, it takes a long time to communicate the reserve condition for the exclusion control via the network communication means, and overhead of access of the host computer must be great with respect to the storage units.

In case of using the DRL technology or the COW technology for the copy, the reserve condition of the access right on the backing store volume must be controlled (exclusion-controlled). In this case too, it takes a long time to communicate the reserve condition for the exclusion control via the network communication means, and overhead of access of the host computer must be great with respect to the storage units.

### SUMMARY OF THE INVENTION

The present invention was conceived to solve the above described problems.

An object of the present invention is to provide a storage virtualization switch, which is capable of omitting to control (exclusion-control) a reserve condition on a physical storage unit without decreasing fault tolerance and reliability of a multinode system, so as to make overhead of access to the storage unit smaller.

Another object is to provide a computer system including said storage virtualization switches.

To achieve the objects, the present invention has following structures.

Namely, the storage virtualization switch of the present invention comprises: connection terminals, to which a host computer and a physical storage unit can be connected; storage virtualization means for constituting a virtual storage unit, to which the host computer can access, by using a part or a whole of a storage area of the physical storage unit; communication means for communicating with another storage virtualization switch; and zoning means for making the host computer recognize an external virtual storage unit constituted in another storage virtualization switch connected by the communication means, the zoning means making the host computer access the external virtual storage unit via the communication means when the host computer requests to access the virtual storage unit.

With this structure, the zoning means makes the host computer access the external virtual storage unit constituted in another storage virtualization switch when the host computer requests to access the virtual storage unit. Therefore, the storage area of the physical storage unit, which corresponds to a particular virtual storage unit, is accessed by another storage virtualization switch only, so that the communication for exclusion-controlling the reserve condition between the storage virtualization switches can be omitted and overhead of access of the host computer can be small.

The storage virtualization switch may further comprise access accepting means for accepting a request to access the virtual storage unit, which is sent from another storage virtualization switch connected by the communication means. With this structure, the request to access the virtual storage unit, which is sent from another storage virtualization switch, can be accepted.

The storage virtualization switch may further comprise access setting means for setting an object storage unit to be accessed, which is selected from the virtual storage unit and the external virtual storage unit, when the host computer sends the access request, and the storage virtualization means is capable of constituting the virtual storage unit, whose structure is the same as that of the external virtual storage unit in another storage virtualization switch connected by the communication means. With this structure, the access setting means is capable of selecting the object storage unit from the virtual storage unit of the storage virtualization switch and the external virtual storage unit of another storage virtualization switch.

In the storage virtualization switch, the access setting means may change the object storage unit to the external virtual storage unit when a failure is detected in a path corresponding to the physical storage unit constituting the virtual storage unit. With this structure, the object storage unit can be changed to the external virtual storage unit, whose structure is the same as that of the virtual storage unit, and accessed via another storage virtualization switch when the failure is detected in the path between the storage virtualization switch and the physical storage unit, so that the fault tolerance and the reliability of the computer system can be improved.

In the storage virtualization switch, the access setting means may set the object storage unit, which is selected from the virtual storage units or the external virtual storage units, for each of the virtual storage units or each of virtual targets, which is connected to each of the virtual storage units. With this structure, the storage virtualization switch, which accesses the physical storage unit, can be set for each of the virtual storage units or each of the virtual targets, so that concentrating access loads to one of the storage virtualization switches can be prevented.

The storage virtualization switch may further comprise: copy means for copying the storage area of the virtual storage unit to a storage area of another virtual storage unit; and copy logging means for logging if the copy means copies each of unit areas of the storage area to be copied or not in a log. With this structure, only the specified storage virtualization switch, which accesses the physical storage, writes the log, so that the communication for controlling (exclusion-controlling) the reserve condition on a backing store volume can be omitted between the storage virtualization switches and overhead of access of the host computer can be small.

In the storage virtualization switch, the copy logging means may store the log in a specified storage area of the physical storage unit.

In the storage virtualization switch, the communication means may communicate with another storage virtualization switch via one of the connection terminals. With this structure, the connection terminals and connection protocols for connecting the physical storage unit and the host computer can be applied for communication with another storage virtualization switch, so that the simple structure, in which a structure and resources of the communication means can be simplified, can be realized.

In the storage virtualization switch, the connection terminals may be fiber channel connection terminals.

Next, the computer system of the present invention comprises: a host computer; a physical storage unit; and a plurality of storage virtualization switches being respectively connected to the host computer and the physical storage unit, each of the storage virtualization switches comprises: connection terminals, to which the host computer and the physical storage unit can be connected; storage virtualization means for constituting a virtual storage unit, to which the host computer can access, by using a part or a whole of a storage area of the physical storage unit; communication means for communicating with another storage virtualization switch; zoning means for making the host computer recognize an external virtual storage unit constituted in another storage virtualization switch connected by the communication means, the zoning means making the host computer access the external virtual storage unit via the communication means when the host computer requests to access the virtual storage unit; access accepting means for accepting a request to access the storage virtualization switch, which is sent from another storage virtualization switch connected by the communication means; and access setting means for setting an object storage unit to be accessed, which is selected from the virtual storage unit and the external virtual storage unit, when the host computer sends the access request, and the virtual storage units of the storage virtualization switches have the same structures, the access setting means of one of the storage virtualization switches sets the virtual storage unit of the one storage virtualization switch as the object storage unit when the host computer sends the access request, and the access setting means of another storage virtualization switch makes the zoning means set the virtual storage unit of the one storage virtualization switch as the object storage unit when the host computer sends the access request.

With this structure, the storage area of the physical storage unit, which corresponds to the virtual storage units having the same structure, is accessed by one of the storage virtualization switches only, so that the communication for exclusion-controlling the reserve condition between the storage virtualization switches can be omitted and overhead of access of the host computer can be small.

In the computer system, the access setting means may change the object storage unit to the external virtual storage unit when a failure is detected in a path corresponding to the physical storage unit constituting the virtual storage unit. With this structure, the object storage unit can be changed to the external virtual storage unit, whose structure is the same as that of the virtual storage unit, via another multinode storage virtualization switch when the failure is detected in the path between the storage virtualization switch, which accesses the physical storage unit, and the physical storage unit, so that the fault tolerance and the reliability of the computer system can be improved.

In the computer system, the access setting means may set the object storage unit, which is selected from the virtual storage units or the external virtual storage units, for each of the virtual storage units or each of virtual targets, which is connected to each of the virtual storage units. With this structure, the storage virtualization switch, which accesses the physical storage unit, can be set for each of the virtual storage units or each of the virtual targets, so that concentrating access loads to one of the storage virtualization switches can be prevented.

Each of the storage virtualization switch may further comprise: copy means for copying the storage area of the virtual storage unit to a storage area of another virtual storage unit; and copy logging means for logging if the copy means copies each of unit areas of the storage area to be copied or not in a log. With this structure, only one of the storage virtualization switches, which accesses the physical storage corresponding the specified virtual storage unit, writes the log, so that the communication for controlling (exclusion-controlling) the reserve condition on a backing store volume can be omitted between the storage virtualization switches and overhead of access of the host computer can be small.

In the computer system, the copy logging means may store the log in a specified storage area of the physical storage unit.

In the computer system, the communication means may communicate with another storage virtualization switch via one of the connection terminals. With this structure, the connection terminals and connection protocols for connecting the physical storage unit and the host computer can be applied for communication with another storage virtualization switch, so that the simple structure, in which a structure and resources of the communication means can be simplified, can be realized.

In the computer system, the connection terminals may be fiber channel connection terminals, and the host computer and the physical storage unit may be connected to the storage virtualization switches by fiber channels.

In the storage virtualization switch and the computer system of the present invention, the control (exclusion control) of the reserve condition on the physical storage unit can be omitted without decreasing fault tolerance and reliability of the multinode system, so that overhead of access to the storage unit can be smaller.

### BRIEF DESCRIPTION OF THE DRAWINGS

Embodiments of the present invention will now be described by way of examples and with reference to the accompanying drawings, in which:

FIG. 1 is a block diagram of a computer system relating to the present invention;

FIG. 2 is a block diagram of a storage virtualization switch relating to the present invention;

FIG. 3 is an explanation view showing functions of access setting means, zoning means and access accepting means;

FIG. 4 is an explanation view showing a function of copy means;

FIG. 5 is an explanation view showing functions of access setting means, zoning means and access accepting means;

FIG. 6 is a block diagram of the computer system including the conventional storage virtualization switch;

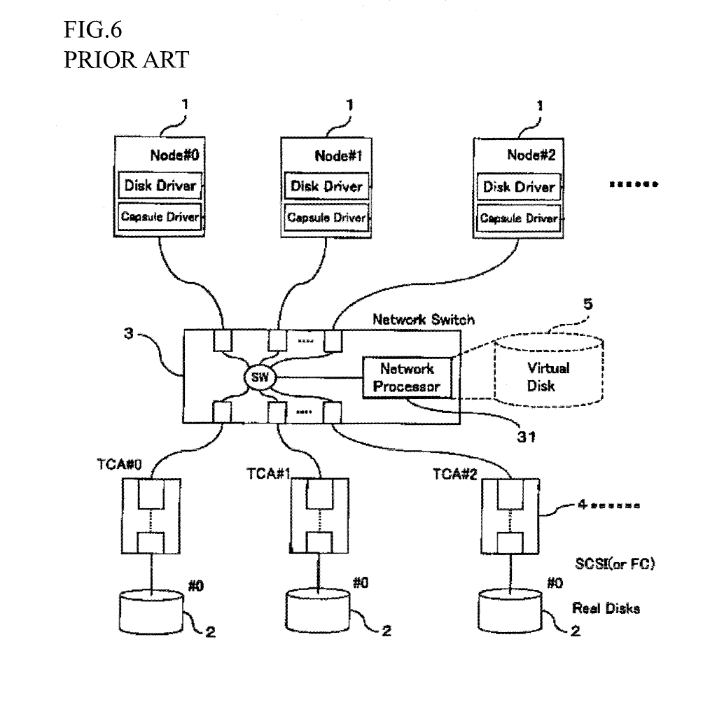

FIG. 7 is a block diagram of the conventional computer system; and

FIG. 8 is an explanation view showing the DRL technology and the COW technology.

### DETAILED DESCRIPTION OF THE EMBODIMENTS

Preferred embodiments of the present invention will now be described in detail with reference to the accompanying drawings.

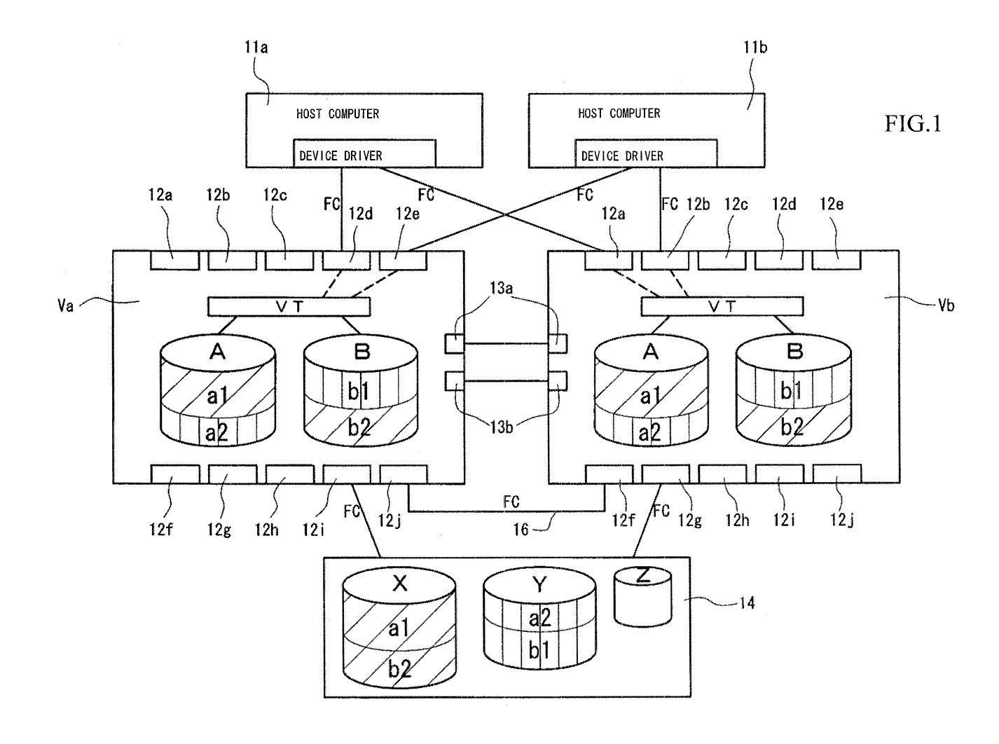

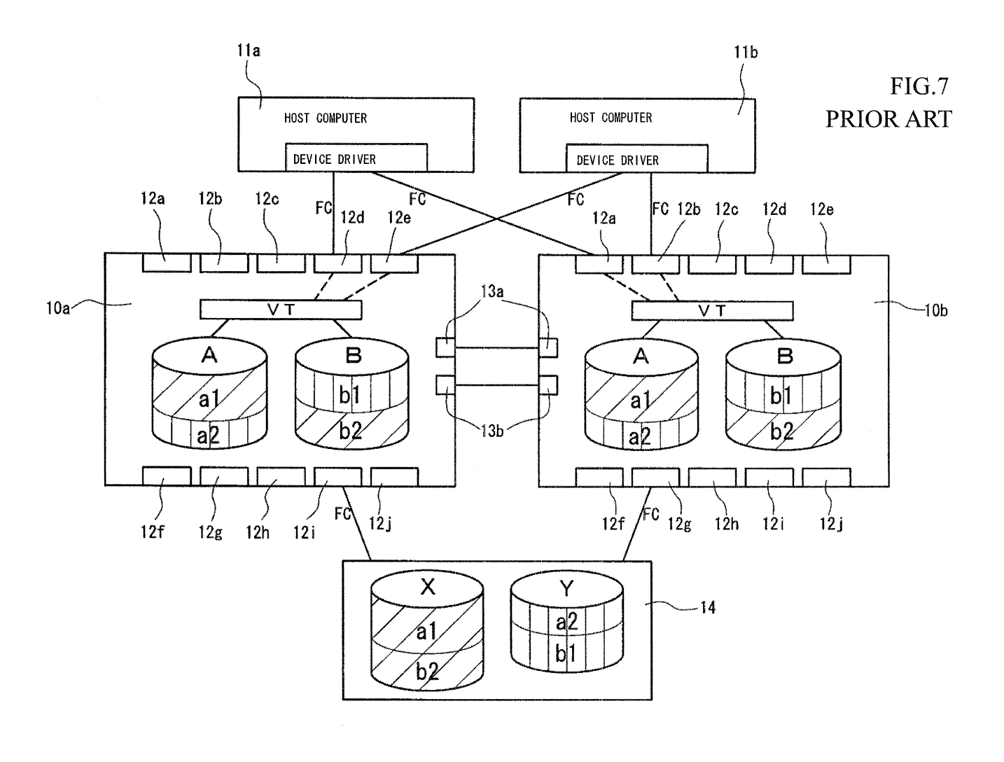

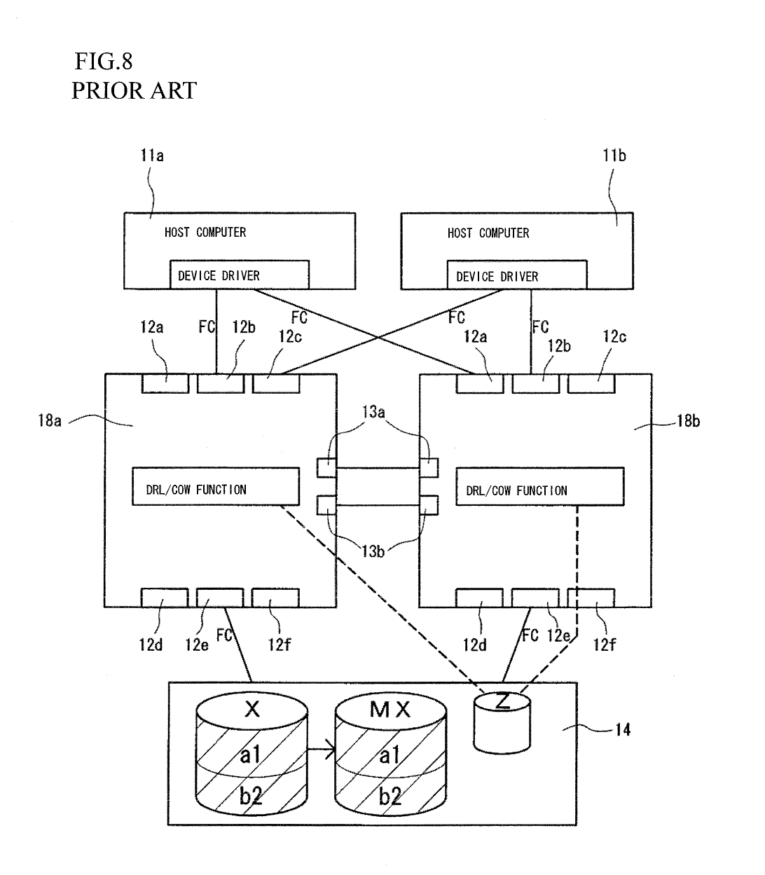

An embodiment of the computer system relating to the present invention is shown in FIG. 1. Basic structures of the storage virtualization switches and the computer system of the present embodiment are similar to those of the conventional storage virtualization switches and the conventional computer system shown in FIGS. 7 and 8. The structural elements shown in FIGS. 7 and 8 are assigned the same symbols and explanation will be omitted.

In the present embodiment, storage virtualization switches Va and Vb are employed instead of the conventional storage virtualization switches 10a and 10b, and the storage virtualization switches Va and Vb are capable of communicating via not only the network communication means 13a and 13b but also fiber channels 16.

Firstly, the storage virtualization switches Va and Vb, which are important elements of the computer system, will be explained.

Each of the storage virtualization switches Va and Vb has a plurality of fiber channel connection terminals 12a-12j, to which the host computers 11a and 11b and the RAID storage unit 14 including the physical storage units X and Y can be connected by fiber channels FC. Fiber channel cables, e.g., coaxial cables, optical fiber cables, which correspond to the fiber channels FC, can be connected to the fiber channel connection terminals 12a-12j. Namely, the host computers 11a and 11b and the RAID storage unit 14 are connected to the fiber channel connection terminals 12a-12j by the fiber channel cables.

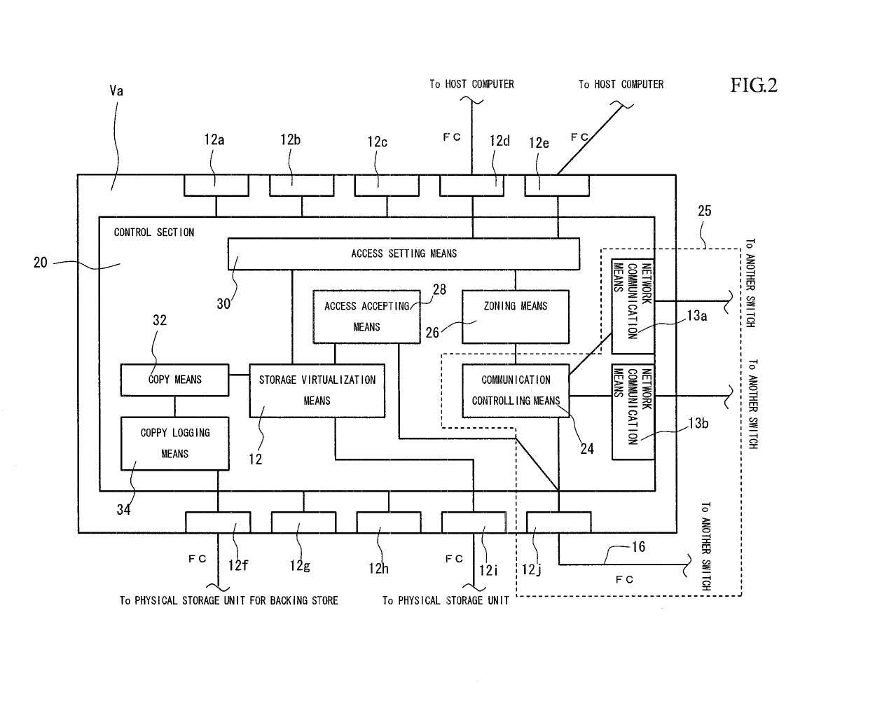

FIG. 2 is a block diagram of the storage virtualization switch Va. Note that, the structure of the storage virtualization switch Vb is the same as that of the storage virtualization switch Va, so the storage virtualization switch Vb is omitted in FIG. 2.

The storage virtualization switch Va has a control section 20 constituted by a CPU, LSIs, memories, etc. The CPU of the control section 20 executes firmware programs stored in ROMs and functions of LSIs so as to act as storage virtualization means 22, communication controlling means 24, zoning means 26, access accepting means 28, access setting means 30, copy means 32, copy logging means 34 and the network communication means 13a and 13b.

### (Storage Virtualization Means 22)

The storage virtualization means 22 constitutes virtual storage units A and B by using parts or wholes of storage areas of the physical storage units X and Y, which are connected to the fiber channel connection terminal 121 (see FIG. 1). The storage virtualization means 22 constitutes a virtual target VT, so that the host computers 11a and 11b are capable of accessing the virtual storage units A and B.

The storage virtualization means 22 accesses corresponding storage areas of the physical storage units X and Y, via the fiber channel connection terminal 121, on the basis of access signals for accessing the virtual storage units A and B, which are sent from the host computers 11a and 11b via the fiber channel connection terminals 12d and 12e.

In the computer system of the present embodiment, the structures of the virtual storage units A and B of the storage virtualization switch Va are the same as those of the storage virtualization switch Vb. Namely, the multinode system is constituted in the computer system.

Note that, the structures of the virtual storage units constituted by the storage virtualization switches Va and Vb are not limited to the example shown in FIG. 1. The virtual storage units may be constituted by optionally combining parts or wholes of the storage areas of the physical storage units.

### (Communication Means 25)

The communication means 25 is used for communicating with the other storage virtualization means.

In the present embodiment, the communication means 25 of the storage virtualization switch Va has two kinds of communication means. One of the communication means uses the network communication means 13a and 13b, which are capable of communicating with the storage virtualization switch Vb by Ethernet (registered trademark); the other communicates with the storage virtualization switch Vb via the fiber channel connection terminal 12j.

The communication controlling means 24 processes and analyzes data, which are sent to and received from the other storage virtualization switch Vb via the network communication means 13a and 13b or the fiber channel connection terminal 121.

In the present embodiment, the communication between the storage virtualization switches Va and Vb is usually performed via the fiber channel connection terminals 12j. In case of breaking down the fiber channel communication due to failure, the communication controlling means 24 using the network communication means 13a and 13b is used.

### (Zoning Means 26)

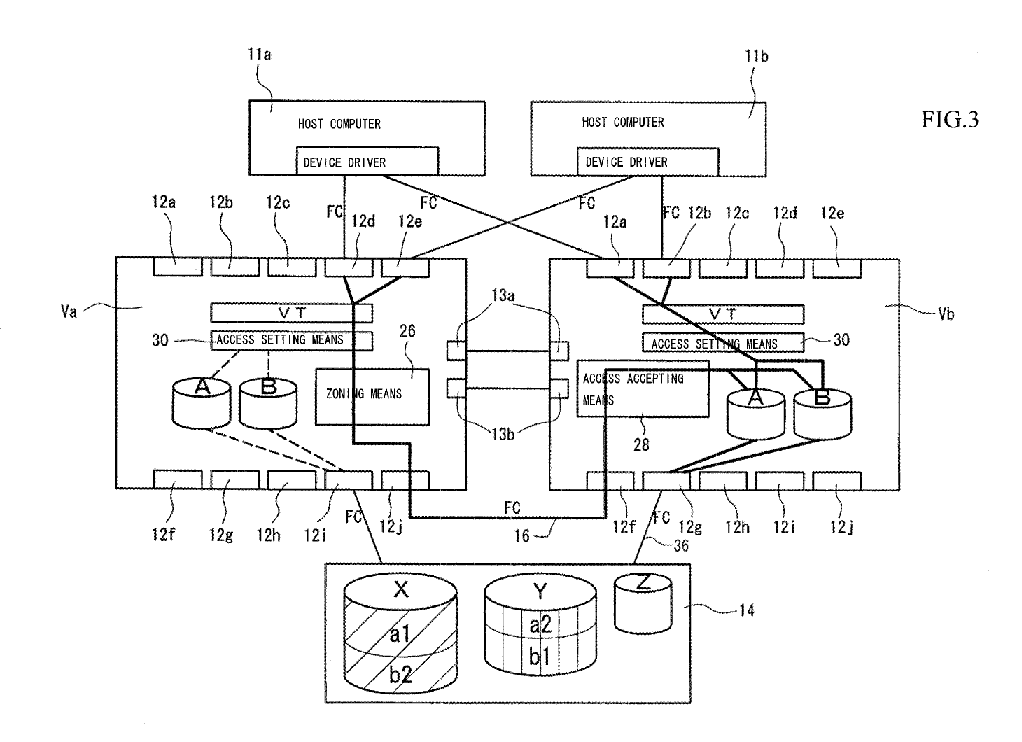

FIG. 3 shows functions of the access setting means 30, the zoning means 26 and the access accepting means 28. As shown by thick solid lines in FIG. 3, the zoning means 26 of the storage virtualization switch Va makes the host computers 11a and 11b recognize the virtual storage units (external virtual storage units) A and B of the other storage virtualization switch Vb. When the host computers 11a and 11b request the storage virtualization switch Va to access the virtual storage units A and B, the zoning means 26 makes the host computers 11a and 11b access the virtual storage units (external virtual storage units) A and B of the other storage virtualization switch Vb.

In the present invention, the virtual storage units of other storage virtualization switch or switches with respect to a specified storage virtualization switch are called “external virtual storage unit(s)”. For example, the virtual storage units of the storage virtualization switch Vb are the external virtual storage units with respect to the storage virtualization switch Va; the virtual storage units of the storage virtualization switch Va are the external virtual storage units with respect to the storage virtualization switch Vb.

### (Access Accepting Means 28)

The access accepting means 28 accepts the access performed by the zoning means 26 of the other storage virtualization switch. In the example shown in FIG. 3, the access accepting means 28 of the storage virtualization switch Vb accepts the access request of the storage virtualization switch Va for accessing the virtual storage units of the storage virtualization switch Vb.

### (Access Setting Means 30)

When the host computers 11a and 11b request to access, the access setting means 30 of the storage virtualization switch Va sets the virtual storage units of the storage virtualization switch Va or the virtual storage units of the storage virtualization switch Vb (external virtual storage units) as object storage units to be accessed.

In the computer system of the present embodiment, the access setting means 30 of the storage virtualization switch Va is set to make the host computers 11a and 11b access the virtual storage units A and B of the storage virtualization switch Vb (external virtual storage units) as the object storage units via the zoning means 26 when the host computers 11a and 11b request access. On the other hand, the access setting means 30 of the storage virtualization switch Vb is set to make the host computers 11a and 11b access the virtual storage units A and B of the storage virtualization switch Va as the object storage units when the host computers 11a and 11b request access.

The access setting means 30 of the storage virtualization switch Va changes the object storage units to the virtual storage units A and B of the storage virtualization switch Vb (external virtual storage units) via the zoning means 26 when a failure or failures are detected in a path or paths corresponding to the physical storage units X and Y constituting the virtual storage units A and B of the storage virtualization switch Va.

In the computer system of the present embodiment, the access setting means 30 of the storage virtualization switch Vb is initially set to make the host computers 11a and 11b access the virtual storage units A and B of the storage virtualization switch Vb as the object storage units when the host computers 11a and 11b request access.

The storage virtualization switches Va and Vb respectively have monitor means (not shown) for periodically monitoring conditions of the paths. If a failure is detected in the path 36 (see FIG. 3), which corresponds to the physical storage units X and Y corresponding to the virtual storage units A and B of the storage virtualization switch Vb, by the monitoring means, the access setting means 30 of the storage virtualization switch Vb changes the object storage units of the host computers 11a and 11b to the virtual storage units A and B of the storage virtualization switch Va (external virtual storage units) via the zoning means 26.

At that time, the access setting means 30 of the storage virtualization switch Vb sends a signal for indicating the change of the setting of the access setting means 30 to the storage virtualization switch Va via the communication means 25.

Contrary to the state shown in FIG. 3, upon receiving the signal, the access setting means 30 of the storage virtualization switch Va changes the object storage units so as to make the host computers 11a and 11b access the virtual storage units A and B of the storage virtualization switch Va.

By the setting action, the relationship of the storage virtualization switches Va and Vb (the settings of the access setting means 30 of the both switches Va and Vb) are mutually replaced.

### (Copy Means 32 & Copy Logging Means 34)

The copy means 32 copies contents of the storage area(s) of the virtual storage area(s), which is constituted by the storage virtualization means 22, to a storage area(s) of another virtual storage unit(s). For example, the copy means 32 performs the mirroring process, in which the same contents are stored in a plurality of physical units by copying the contents of the storage areas of the virtual storage units to those of other virtual storage units, and the snapshot process, in which data stored in copy source virtual storage units are copied to copy destination virtual storage units at a particular time.

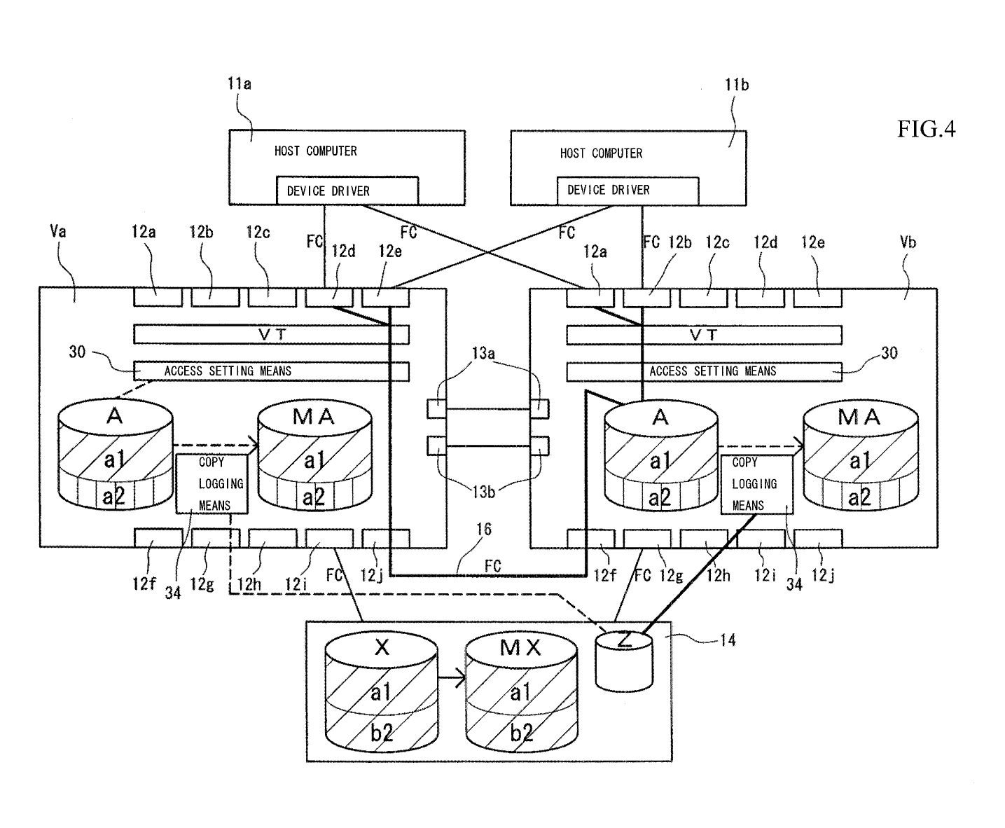

The copy function and the copy process of the computer system will be explained with reference to FIG. 4. Note that, the virtual storage units A and the physical storage unit X are shown in FIG. 4, and the virtual storage units B and the physical storage unit Y are omitted for easily understanding.

When the copy means 32 copies data, the storage virtualization switches Va and Vb constitute copy destination virtual storage units MX, e.g., mirror volumes, which respectively correspond to the copy source virtual storage units A. The RAID storage unit 14 includes a copy destination physical storage unit MX, which corresponds to the copy source physical storage unit X.

The mirroring process performed in the computer system will be explained. When an access request is sent to the virtual storage unit A and data are written in the physical storage unit X, which corresponds to the storage area of the virtual storage unit A, the copy means 32 copies the written data from the virtual storage unit A to the copy destination virtual storage unit MA. Namely, the data are copied from the physical storage unit X to the copy destination physical storage unit MX.

On the other hand, if the host computer 11a or 11b sends a command for performing the snapshot process for copying data to the storage virtualization switch Vb directly or via the other storage virtualization switch Va, the copy means 32 copies data in the designated storage area of the virtual storage unit A to the copy destination virtual storage unit MA. Namely, the data are copied from the physical storage unit X to the copy destination physical storage unit MX.

The DRL technology and the COW technology for copying data can be performed in the computer system of the present embodiment. In case that data are written in the virtual storage unit A by performing the mirroring process, etc. but the data cannot be copied due to a failure, etc., the copy logging means 34, which performs logging functions of the DRL technology and the COW technology, records a log datum, which indicates that the written data are not copied to the copy destination virtual storage unit MA (the physical storage unit MX), in a backing store volume (physical storage unit for logging) Z.

Note that, the DRL technology and the COW technology have been explained in BACKGROUND OF THE INVENTION, so explanation will be omitted.

Preferably, the access setting means sets the object storage units, which are selected from the virtual storage units or the external virtual storage units, for each of the virtual storage units A and B or each of virtual targets VT, which is connected to each of the virtual storage units A and B.

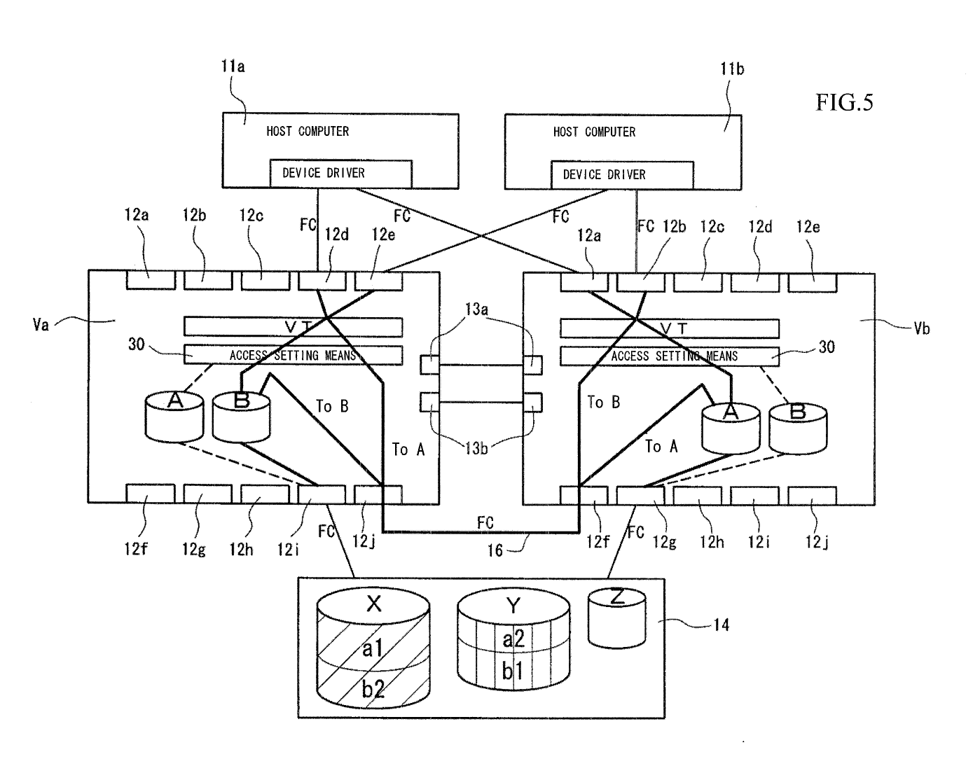

For example, in the computer system shown in FIG. 5, the access to the physical storage unit, which corresponds to the virtual storage unit A, is performed via the storage virtualization switch Vb (“To A” in FIG. 5); the access to the physical storage unit, which corresponds to the virtual storage unit B, is performed via the storage virtualization switch Va (“To B” in FIG. 5). The virtual storage units or the virtual targets are respectively assigned to the storage virtualization switches accessing the physical storage units. Unlike the conventional computer system in which a particular storage virtualization switch accesses the physical storage units, access loads can be distributed to a plurality of the storage virtualization switches, so that overhead of file access of the compute system can be smaller.

In the present invention, number of the multinode storage virtualization switches of the computer system is not limited to two. Three or more multinode storage virtualization switches may be employed. In that case, the access setting means 30 of each of the storage virtualization switches is set to allow one of the storage virtualization switches to access the physical storage unit corresponding to the designated virtual storage unit.

In the computer system of the present embodiment including the storage virtualization switches Va and Vb, only the storage virtualization switch Vb accesses the storage areas of the physical storage units X and Y, which correspond to the virtual storage units A and B. Therefore, communication for controlling (exclusion-controlling) the reserve condition is not required between the storage virtualization switches Va and Vb, so that overhead of access of the host computers 11a and 11b can be made smaller.

When a failure is detected in the path 36 between the storage virtualization switch Vb, which accesses the physical storage units X and Y, and the physical storage units X and Y, the host computers can access the external virtual storage units A and B having the same structures via the other storage virtualization switch Va. Therefore, fault tolerance and reliability can be increased.

Since the fiber channel connection terminals and connection protocols for connecting the host computers to the physical storage units can be used for the communication between the storage virtualization switches Va and Vb, the simple structure, in which structures and resources of the communication means 25 are simplified, can be realized.

In case of using the COW technology and the DRL technology for copying data between the virtual storage units A and B, only one of the storage virtualization switches, which accesses the physical storage corresponding the specified virtual storage unit, writes the log, so that the communication for controlling (exclusion-controlling) the reserve condition on the backing store volume can be omitted between the storage virtualization switches. Therefore, the overhead of access of the host computers can be small.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A storage virtualization switch,
comprising:
connection terminals, to which a host computer and a physical storage unit can be connected;
storage virtualization means for constituting a virtual storage unit, to which the host computer can access, by using a part or a whole of a storage area of the physical storage unit;
communication means for communicating with another storage virtualization switch; and
zoning means for making the host computer recognize an external virtual storage unit constituted in another storage virtualization switch connected by said communication means, said zoning means making the host computer access the external virtual storage unit via said communication means when the host computer requests to access the virtual storage unit.

2. The storage virtualization switch according to claim 1,
further comprising access accepting means for accepting a request to access the virtual storage unit, which is sent from another storage virtualization switch connected by said communication means.

3. The storage virtualization switch according to claim 1,
further comprising access setting means for setting an object storage unit to be accessed, which is selected from the virtual storage unit and the external virtual storage unit, when the host computer sends the access request,
wherein said storage virtualization means is capable of constituting the virtual storage unit, whose structure is the same as that of the external virtual storage unit in another storage virtualization switch connected by said communication means.

4. The storage virtualization switch according to claim 3,
wherein said access setting means changes the object storage unit to the external virtual storage unit when a failure is detected in a path corresponding to the physical storage unit constituting the virtual storage unit.

5. The storage virtualization switch according to claim 3,
wherein said access setting means sets the object storage unit, which is selected from the virtual storage units or the external virtual storage units, for each of the virtual storage units or each of virtual targets, which is connected to each of the virtual storage units.

6. The storage virtualization switch according to claim 1,
further comprising:
copy means for copying the storage area of the virtual storage unit to a storage area of another virtual storage unit; and
copy logging means for logging if said copy means copies each of unit areas of the storage area to be copied or not in a log.

7. The storage virtualization switch according to claim 6,
wherein said copy logging means stores the log in a specified storage area of said physical storage unit.

8. The storage virtualization switch according to claim 1,
wherein said communication means communicates with another storage virtualization switch via one of said connection terminals.

9. The storage virtualization switch according to claim 1,
wherein said connection terminals are fiber channel connection terminals.

10. A computer system,
comprising:
a host computer;
a physical storage unit; and
a plurality of storage virtualization switches being respectively connected to said host computer and said physical storage unit,
wherein each of said storage virtualization switches comprises:
connection terminals, to which said host computer and said physical storage unit can be connected;
storage virtualization means for constituting a virtual storage unit, to which said host computer can access, by using a part or a whole of a storage area of said physical storage unit;
communication means for communicating with another storage virtualization switch;
zoning means for making said host computer recognize an external virtual storage unit constituted in another storage virtualization switch connected by said communication means, said zoning means making said host computer access the external virtual storage unit via said communication means when said host computer requests to access the virtual storage unit;
access accepting means for accepting a request to access said storage virtualization switch, which is sent from another storage virtualization switch connected by said communication means; and
access setting means for setting an object storage unit to be accessed, which is selected from the virtual storage unit and the external virtual storage unit, when said host computer sends the access request, and
the virtual storage units of said storage virtualization switches have the same structures,
the access setting means of one of said storage virtualization switches sets the virtual storage unit of the one storage virtualization switch as the object storage unit when said host computer sends the access request, and
the access setting means of another storage virtualization switch makes said zoning means set the virtual storage unit of the one storage virtualization switch as the object storage unit when said host computer sends the access request.

11. The computer system according to claim 10,
wherein said access setting means changes the object storage unit to the external virtual storage unit when a failure is detected in a path corresponding to the physical storage unit constituting the virtual storage unit.

12. The computer system according to claim 10,
wherein said access setting means sets the object storage unit, which is selected from the virtual storage units or the external virtual storage units, for each of the virtual storage units or each of virtual targets, which is connected to each of the virtual storage units.

13. The computer system according to claim 10,
wherein each of said storage virtualization switch further comprises:
copy means for copying the storage area of the virtual storage unit to a storage area of another virtual storage unit; and
copy logging means for logging if said copy means copies each of unit areas of the storage area to be copied or not in a log.

14. The computer system according to claim 13,
wherein said copy logging means stores the log in a specified storage area of said physical storage unit.

15. The computer system according to claim 10,
wherein said communication means communicates with another storage virtualization switch via one of said connection terminals.

16. The computer system according to claim 10,
wherein said connection terminals are fiber channel connection terminals, and
said host computer and said physical storage unit are connected to said storage virtualization switches by fiber channels.
